(19) United States
(12) Patent Application Publication
(10) Pub. No.: US 2008/0074579 A1
(43) Pub. Date: Mar. 27, 2008

(54) Backlight module with reflective plate and liquid crystal display employing same

(75) Inventor: Chih-Chia Yu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/904,004

(22) Filed: Sep. 24, 2007

(30) Foreign Application Priority Data
Sep. 22, 2006 (TW) 95135190

(51) Int. Cl. G02F 1/1335; F21V 7/04

(52) U.S. Cl. 349/64; 362/619

(57) ABSTRACT

An exemplary backlight module includes a light guide plate (330) and a frame (340). The light guide plate includes a light emitting surface (331) and a bottom surface (332) at opposite of the light guide plate. The frame is configured for accommodating the light guide plate. The frame includes a bottom plate (341). The bottom plate includes a reflective surface (343) abutting the bottom surface of the light guide plate.

### FIELD OF THE INVENTION

The present invention relates to backlight modules such as those used in liquid crystal displays (LCDs); and more particularly to a backlight module having a bottom plate with a reflective surface, and a liquid crystal display employing such backlight module.

### BACKGROUND

Liquid crystal displays (LCDs) are widely applied in various electrical products such as personal digital assistants (PDAs), notebook computers, digital cameras, digital camcorders, mobile telephones, computer monitors, liquid crystal televisions, and the like. This is because the technology for manufacturing LCDs has rapidly developed, and because LCDs have advantages such as being light in weight, thin, power-saving, and radiation-free. However, a liquid crystal panel of a liquid crystal display cannot emit light by itself. Rather, a light source such as ambient sunlight or a backlight installed in the LCD is needed. Thus a typical LCD includes a backlight module installed adjacent to the liquid crystal panel, for providing light rays to the liquid crystal panel.

Referring to FIG. 3, an exploded, isometric view of a typical liquid crystal display 1 is shown. The liquid crystal display 1 includes a top bezel 10, a liquid crystal panel 20, a backlight module 40 at the rear of the liquid crystal panel 20, and a bottom tray 50. The top bezel 10 is disposed on the liquid crystal panel 20 for protecting the liquid crystal panel 20. The bottom tray 50 is disposed under the backlight module 40 for protecting the backlight module 40. The top bezel 10 together with the bottom tray 50 cooperatively accommodate the liquid crystal panel 20 and the backlight module 40.

The backlight module 40 includes a frame-shaped piece of double-sided adhesive masking tape 410, an optical film assembly 420, a light guide plate (LGP) 430, a plurality of illuminators 440, a reflective film 460, and a frame 450. The reflective film 460 is adhered to the frame 450. The frame 450 is capable of accommodating the masking tape 410, the optical film assembly 420, the illuminators 440, the LGP 430 and the reflective film 460, generally in that order from top to bottom. The masking tape 410 has a size corresponding to that of the liquid crystal panel 20, and defines a center window (not labeled). The window allows light rays exiting the optical film assembly 420 to pass through to the liquid crystal panel 20.

The LGP 430 includes a light incident surface 433, a light emitting surface 431, a bottom surface 432, and two side surfaces 434. The light incident surface 433 is adjacent to the illuminators 440. The light emitting surface 431 perpendicularly connects with the light incident surface 433. The bottom surface 432 and the light emitting surface 431 are at opposite sides of the LGP 430. The side surfaces 434 perpendicularly connect with the light incident surface 433, the light emitting surface 431, and the bottom surface 432. That is, the light incident surface 433 and the side surfaces 434 are between the light emitting surface 431 and the bottom surface 432.

Each side surface 434 has a pair of protruding portions 435 extended outwardly therefrom. The protruding portions 435 are adjacent to end portions (not labeled) of the side surface 434, respectively. The frame 450 has a plurality of notches 455 defined therein. Each protruding portion 435 corresponds to one of the notches 455. By inserting the protruding portions 435 into the notches 455, the LGP 430 is attached to the frame 450.

The optical film assembly 420 includes an upper diffusing film 421, an upper brightness enhancement film 422, a lower brightness enhancement film 423, and a lower diffusing film 424, in that order from top to bottom. The lower diffusing film 424 is disposed adjacent to the light emitting surface 431 of the LGP 430. The upper diffusing film 421, the upper brightness enhancement film 422, the lower brightness enhancement film 423, and the lower diffusing film 424 are generally rectangular.

Referring also to FIG. 4 and FIG. 5, these show the LGP 430, the frame 450 and the reflective film 460 assembled together. The reflective film 460 is adhered to the frame 450 by a glue layer 465. Thus, an unavoidable interval exists between the reflective film 460 and the LGP 430 held in the frame 450. Therefore leakage of light rays traveling between the LGP 430 and the reflective film 460 is liable to occur. The amount of leakage can be significant. Further, during assembly of the backlight module 40, it can be difficult to precisely locate the reflective film 460 in the correct position. The reflective film 460 may be damaged during this process. When this happens, the performance of the backlight module 40 may be defective.

What is needed, therefore, is a backlight module which can overcome the above-described deficiencies. What is also needed is a liquid crystal display employing such a backlight module.

### SUMMARY

In one preferred embodiment, a backlight module includes a light guide plate and a frame. The light guide plate includes a light emitting surface and a bottom surface at opposite sides of the light guide plate. The frame is configured for accommodating the light guide plate. The frame includes a bottom plate. The bottom plate includes a reflective surface abutting the bottom surface of the light guide plate.

A detailed description of embodiments of the present invention is given below with reference to the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, isometric view of a liquid crystal display according to a first embodiment of the present invention.

FIG. 2 is an exploded, isometric view of a liquid crystal display according to a second embodiment of the present invention.

FIG. 3 is an exploded, isometric view of a conventional liquid crystal display, the liquid crystal display including a light guide plate, a frame, a reflective film, and a bottom tray.

FIG. 4 is an isometric view of the light guide plate, the frame, the reflective film and the bottom tray of FIG. 3 assembled together.

FIG. 5 is an enlarged, cross-sectional view taken along line III-III of FIG. 4.

### DETAILED DESCRIPTION OF PREFERRED EMBODIMENTS

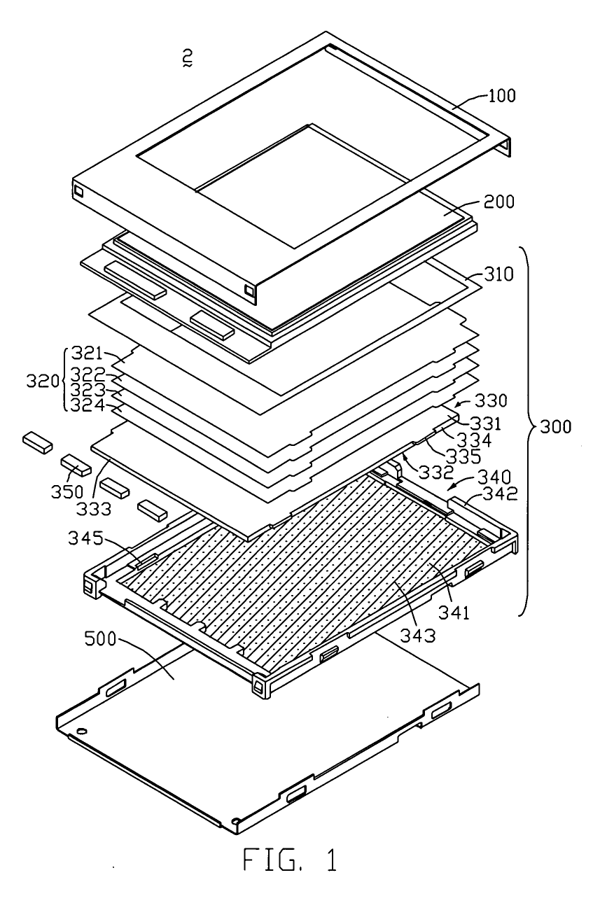

Referring to FIG. 1, a liquid crystal display 2 according to a first embodiment of the present invention is shown. The liquid crystal display 2 includes a top bezel 100, a liquid crystal panel 200, a backlight module 300, and a bottom tray 500, arranged in that order from top to bottom. The top bezel 100 together with the bottom tray 500 cooperatively accommodate the liquid crystal panel 200 and the backlight module 300.

The backlight module 300 includes an optical film assembly 320, a plurality of illuminators 350, an LGP 330, a frame 340, and a frame-shaped piece of double-sided adhesive masking tape 310. In the illustrated embodiment, the illuminators 350 are four light emitting diodes. The masking tape 310 has a size corresponding to that of the liquid crystal panel 200, and defines a center window (not labeled). The window allows light rays exiting the optical film assembly 320 to pass through to the liquid crystal panel 200. The masking tape attaches the optical film assembly 320 onto the frame 340. In addition, the masking tape attaches the liquid crystal panel 200 onto the frame 340 having the optical film assembly 320.

The LGP 330 includes a light incident surface 333, a light emitting surface 331, a bottom surface 332, and two side surfaces 334. The light incident surface 333 is adjacent to the illuminators 340. The light emitting surface 331 perpendicularly connects with the light incident surface 333. The bottom surface 332 and the light emitting surface 331 are at opposite sides of the LGP 330. The side surfaces 334 perpendicularly connect with the light incident surface 333, the light emitting surface 331, and the bottom surface 332. That is, the light incident surface 333 and the side surfaces 334 are between the light emitting surface 331 and the bottom surface 332.

Each side surface 334 has a pair of protruding portions 335 extended outwardly therefrom. The protruding portions 335 are adjacent to end portions (not labeled) of the side surface 334, respectively. In the illustrated embodiment, each protruding portion 335 has a shape of a block.

The frame 340 includes a bottom plate 341, four side plates 342, and four notches 345. The bottom plate 341 perpendicularly connects with each side plate 342. The bottom plate 341 has a reflective surface 343 abutting the bottom surface 332 of the LGP 330. The reflective surface 343 is coated with a reflective material, such as silver, aluminum, or the like. The notches 345 are defined in two opposite lateral of the side plates 342, with two notches 345 defined in each of such side plates 342. In each side plate, the notches 345 are adjacent to end portions (not labeled) of the side plate 342, respectively. Each notch 345 corresponds to one of the protruding portions 335. The reflective surface 343 can reflect light rays escaping from the bottom surface 332 of the LGP 330 back into the LGP 330. The LGP 330 can be attached to the frame 340 by inserting the protruding portions 335 into the corresponding notches 345. The frame 340 is capable of accommodating the masking tape 310, the optical film assembly 320, the illuminators 350, and the LGP 330.

The optical film assembly 320 includes an upper diffusing film 321, an upper brightness enhancement film 322, a lower brightness enhancement film 323, and a lower diffusing film 324, in that order from top to bottom. The lower diffusing film 324 is disposed adjacent to the light emitting surface 331 of the LGP 330. The upper diffusing film 321, the upper brightness enhancement film 322, the lower brightness enhancement film 323, and the lower diffusing film 324 are generally rectangular.

In general, the frame 340 includes a bottom plate 341 having a reflective surface 343 abutting the bottom surface 332 of the LGP 330. The reflective surface 343 can reflect light rays escaping from the bottom surface 332 of the LGP 330 back into the LGP 330. Thus, unlike in conventional backlight modules, there is no need for a reflective film. Accordingly, there are no problems associated with precisely locating a reflective film in the correct position. In addition, the bottom plate 341 can provide sturdy mechanical protection for the LGP 330 and the optical film assembly 320, for example when the backlight module 300 is subjected to external forces such as vibration or shock. This improves the reliability of the backlight module 300.

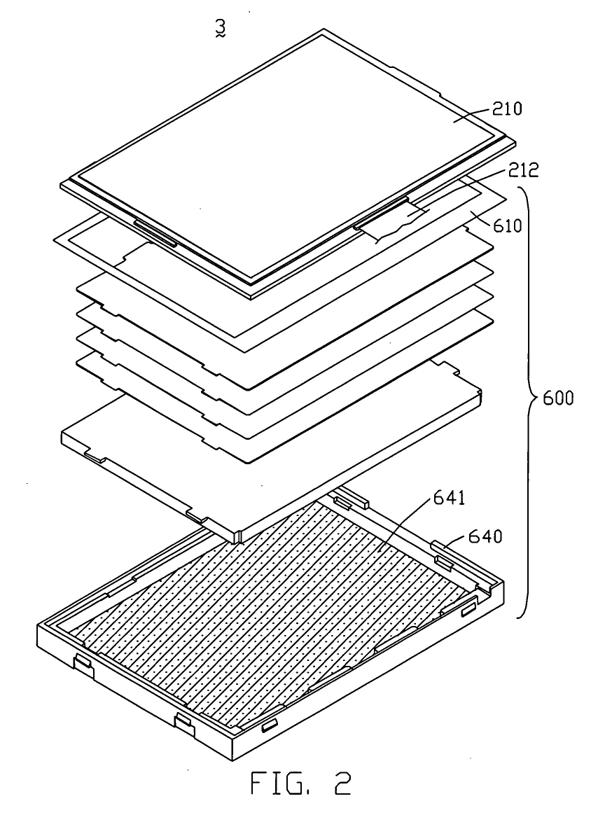

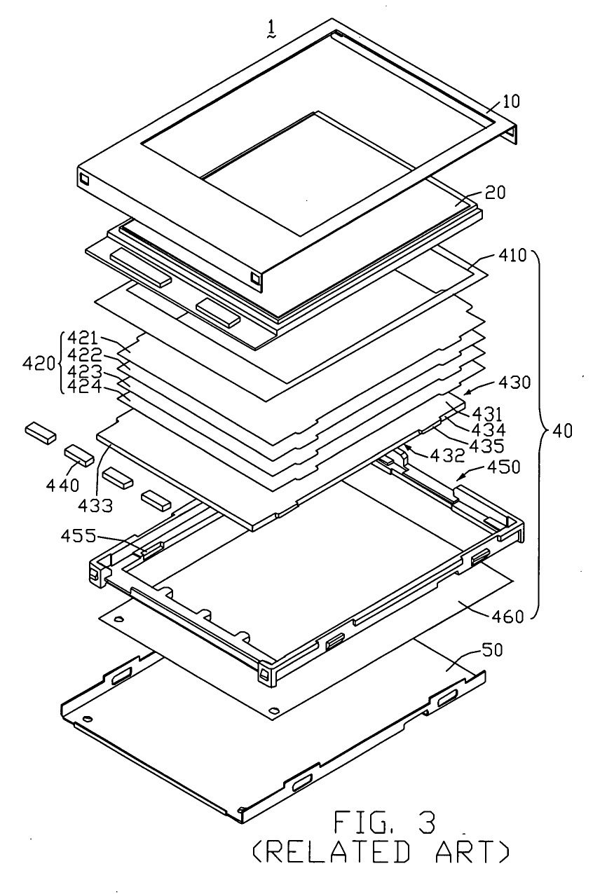

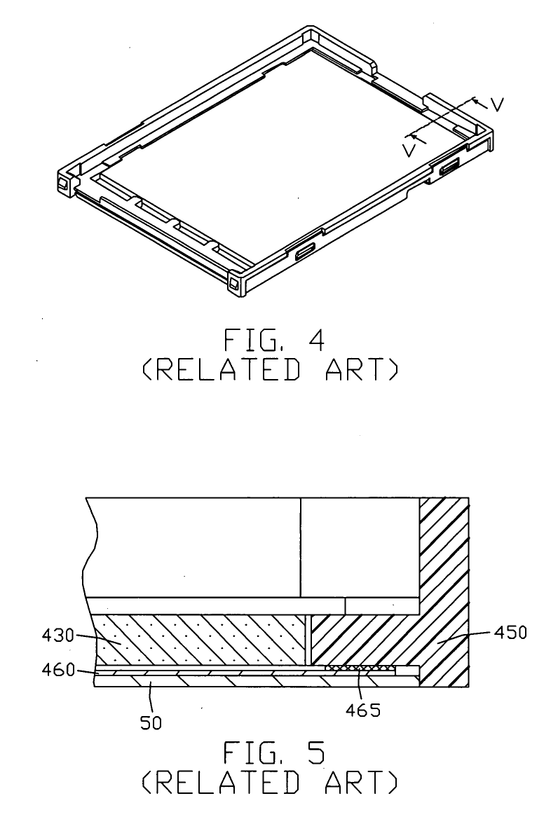

Referring to FIG. 2, a liquid crystal display 3 according to a second embodiment of the present invention is shown. The liquid crystal display 3 includes a liquid crystal panel 210 and a backlight module 600. The liquid crystal panel 210 is similar to the above-described liquid crystal panel 200. The liquid crystal panel 210 includes a flexible printed circuit board (FPC) 212. The backlight module 600 is similar to the above-described backlight module 300. The backlight module 600 includes a frame-shaped piece of double-sided adhesive masking tape 610, and a frame 640 having a bottom plate 641. The bottom plate 641 can protect the FPC 212 from damage. The LCD 3 does not have a top bezel or a bottom tray. Therefore the LCD 3 is suitable for use in portable digital products like mobile phones, portable DVDs, PDAs, etc.

While preferred and exemplary embodiments have been described above, it is to be understood that the embodiments are not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A backlight module comprising:
a light guide plate comprising:
a light emitting surface and a bottom surface at opposite sides of the light guide plate; and
a frame configured for accommodating the light guide plate, the frame comprising a bottom plate, the bottom plate comprising a reflective surface abutting the bottom surface of the light guide plate.

2. The backlight module as claimed in claim 1, wherein the reflective surface is a coating of reflective material on an inner surface of the bottom plate.

3. The backlight module as claimed in claim 1, wherein the light guide plate further comprises a light incident surface adjacent and perpendicular to the light emitting surface.

4. The backlight module as claimed in claim 3, wherein the light guide plate further comprises side surfaces at two opposite sides thereof, each of the side surfaces being perpendicular and adjacent to the light incident surface and the light emitting surface.

5. The backlight module as claimed in claim 1, further comprising an optical film assembly provided adjacent to the light emitting surface of the light guide plate.

6. The backlight module as claimed in claim 5, wherein the optical film assembly comprises a lower diffusing film, a lower brightness enhancement film above the lower diffusing film, an upper brightness enhancement film above the lower brightness enhancement film, and an upper diffusing film above the upper brightness enhancement film.

7. The backlight module as claimed in claim 6, further comprising a frame-shaped piece of double-sided adhesive masking tape attaching the optical film assembly onto the frame.

8. The backlight module as claimed in claim 1, further comprising a plurality of illuminators disposed adjacent to the light emitting surface.

9. A liquid crystal display comprising:
a liquid crystal panel;
a backlight module positioned for illuminating the liquid crystal panel, the backlight module comprising:
a light guide plate comprising:
a light emitting surface;
a light incident surface adjacent and perpendicular to the light emitting surface; and
a bottom surface at opposite sides of the lightguide plate; and
a frame configured for accommodating the light guide plate comprising a bottom plate, the bottom plate comprising a reflective surface abutting the bottom surface of the light guide plate.

10. The liquid crystal display as claimed in claim 9, wherein the backlight module further comprises a plurality of illuminators disposed adjacent to the light emitting surface.

11. The liquid crystal display as claimed in claim 9, wherein the reflective surface is a coating of a reflective material on an inner surface of the bottom plate.

12. The liquid crystal display as claimed in claim 9, wherein the backlight module further comprises an optical film assembly disposed adjacent to the light emitting surface.

13. The liquid crystal display as claimed in claim 12, wherein the optical film assembly comprises a lower diffusing film, a lower brightness enhancement film above the lower diffusing film, an upper brightness enhancement film above the lower brightness enhancement film and an upper diffusing film above the upper brightness enhancement film.

14. The liquid crystal display as claimed in claim 12, wherein the backlight module further comprises a frame-shaped piece of double-sided adhesive masking tape adhered to an engagement of the optical film assembly and the frame.

15. The liquid crystal display as claimed in claim 9, wherein the liquid crystal panel further comprises a flexible printed circuit board.

16. The liquid crystal display as claimed in claim 9, further comprising an upper bezel and a lower bezel, wherein the upper bezel and the lower bezel cooperatively accommodate the liquid crystal panel and the backlight module therebetween.

17. A back light module comprising:
a light guide plate comprising:
a light emitting surface and a bottom surface at opposite sides of the light guide plate; and
a frame configured for accommodating the light guide plate, the frame comprising a bottom plate, the bottom plate comprising a reflective surface confronting the bottom surface of the light guide plate
